(19) United States
(12) Patent Application Publication
(10) Pub. No.: US 2009/0323226 A1
(43) Pub. Date: Dec. 31, 2009

(54) INFORMATION STORAGE DEVICE

(75) Inventor: Yukihiro Komura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/390,978

(22) Filed: Feb. 23, 2009

(30) Foreign Application Priority Data
Jun. 27, 2008 (JP) 2008-169001

(51) Int. Cl. G11B 5/54

(52) U.S. Cl. 360/256.1; G9B/5.181

(57) ABSTRACT

An information storage device that includes: a housing; a disc-shaped recording medium to record data thereon, rotating along a disc surface to generate a wind inside the housing; a head capable of recording and/or reproducing data on and/or from the recording medium; an arm holding the head on its tip end and held by a rotary shaft, the arm rotating about the rotary shaft to move the head along the disc surface; a coil including multiple turns in a plane where the arm rotates, and receiving current supply, the coil fixed to the opposite end of the arm; a magnet generating magnetic field to act on the coil; and an airflow adjusting plate placed adjacent and upstream to the coil along the wind generated by rotation of the recording medium, extending in the plane where the coil includes turns and adjusting flow of the wind to travel along the coil.

### CROSS-REFERENCE TO RELATED APPLICATION

This application is based upon and claims the benefit of priority of the prior Japanese Patent Application No. 2008-169001, filed on Jun. 27, 2008, the entire contents of which are incorporated herein by reference.

### FIELD

The embodiments discussed herein are related to an information storage device that has a built-in recoding medium and records and reproduces information on and from the recording medium.

### BACKGROUND

In the field of computer, a large amount of information has been handled on a daily basis, and a hard disk drive (HDD) is used as one of the information storage devices that record and reproduce such large amount of information. A HDD has features of having a large recording capacity and providing high-speed access to information therein, and generally includes a magnetic disk that is a disc-shaped recording medium, and a magnetic head for recording and reproducing information on and from the magnetic disk.

Here, a typical HDD has a structure including an arm having a magnetic head on its tip end and held by a rotary shaft. The arm rotates about the rotary shaft to move the magnetic head along a disc surface of a magnetic disk, and the magnetic head is positioned relative to the magnetic disk by the rotation of the arm. Further, in the HDD, the arm is rotated by a so-called voice coil motor (for example, see Japanese Laid-open Patent Publication No. 05-28742). In general, if a current is caused to flow through a coil placed in a certain magnetic field, a force acts on the coil. The voice coil motor uses such a force as a driving force for moving the arm as a driving target. Specifically, the typical HDD includes, as a part of the voice coil motor, a coil fixed to the rear end of the arm, which is opposed to the end having the magnetic head across the rotary shaft.

When a current is caused to flow through the coil included in the voice coil motor to move the arm, heat is generated therein. The heat generated in the coil causes problems such as increasing an electric resistance of the coil itself to reduce the current amount flowing through the coil. Therefore, in the HDD, the coil included in the voice coil motor needs to be cooled down while the HDD is in operation.

Generally, in the interior of the HDD, wind is generated by the rotation of the magnetic disk. Thus, in many HDDs, the wind generated by the rotation of the magnetic disk is used to cool the coil included in the voice coil motor (for example, see Japanese Laid-open Patent Publication No. 2001-110151).

However, this wind for cooling the coil included in the voice coil motor often vibrates the coil, and may eventually vibrate the arm to which the coil is fixed. When the arm is vibrated in this manner, this vibration might further vibrate the magnetic head held by the tip end of the arm, which sometimes disturbs information recording and reproducing operations of the recording head. However, if, for example, the coil is shielded from the wind generated by the rotation of the magnetic disk to prevent occurrence of such vibration, the coil cannot be cooled by the wind, which leads to an additional need for cooling means.

### SUMMARY

According to an aspect of the invention, an information storage device includes:

a housing;

a recording medium on which information is recorded, the recording medium having a disc shape, housed in the housing, and rotating along a disc surface to generate a wind inside the housing;

a head capable of recording and/or reproducing information on and/or from the recording medium;

an arm holding the head on a tip end thereof and held by a rotary shaft, the arm rotating about the rotary shaft to move the head along the disc surface of the recording medium;

a coil including multiple turns in a plane where the arm rotates, and receiving current supply, the coil being fixed to an end of the arm opposite to the tip end across the rotary shaft;

a magnet generating a magnetic field to act on the coil; and

an airflow adjusting plate placed at a position adjacent and upstream to the coil along the wind generated by rotation of the recording medium, the airflow adjusting plate extending in the plane where the coil includes turns and adjusting a flow of the wind to travel along the coil.

In the basic embodiment of the information storage device, the so-called voice coil motor is formed by the coil and the magnet. In the voice coil motor, the magnet generates a magnetic field, and thus a force acts on the coil in the magnetic field when a current is supplied thereto. This force drives the coil in a direction to rotate the arm. Here, according to the basic embodiment of the information storage device, the coil is cooled by the wind generated by the rotation of the magnetic disk. At this time, according to the basic embodiment of the information storage device, a flow of this wind for cooling is rectified to a flow along the coil by the airflow adjusting plate. This suppresses the vibration of the coil, and thus suppresses a turbulent flow of the wind that causes the vibration of the arm having the magnetic head on its tip end, so that such vibration of the arm can eventually be suppressed. In other words, according to the basic embodiment of the information storage device, it is possible to cool the coil included in the voice coil motor, while suppressing the vibration of the coil by utilizing the wind generated by the rotation of the recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a hard disk drive (HDD) as a specific embodiment of an information storage device;

FIG. 2 is a view illustrating an internal structure of a voice coil motor in FIG. 1;

FIG. 3 is a schematic view illustrating a state in which vibration occurs in a coil of the voice coil motor on the assumption that no airflow adjusting plate is provided; and

FIG. 4 is a schematic view illustrating a state in which wind blowing against the coil of the voice coil motor is rectified by the airflow adjusting plate of the present embodiment to thereby suppress vibration of the coil.

### DESCRIPTION OF EMBODIMENT

The following will describe a specific embodiment of the information storage device explained as the basic embodiment with reference to the drawings.

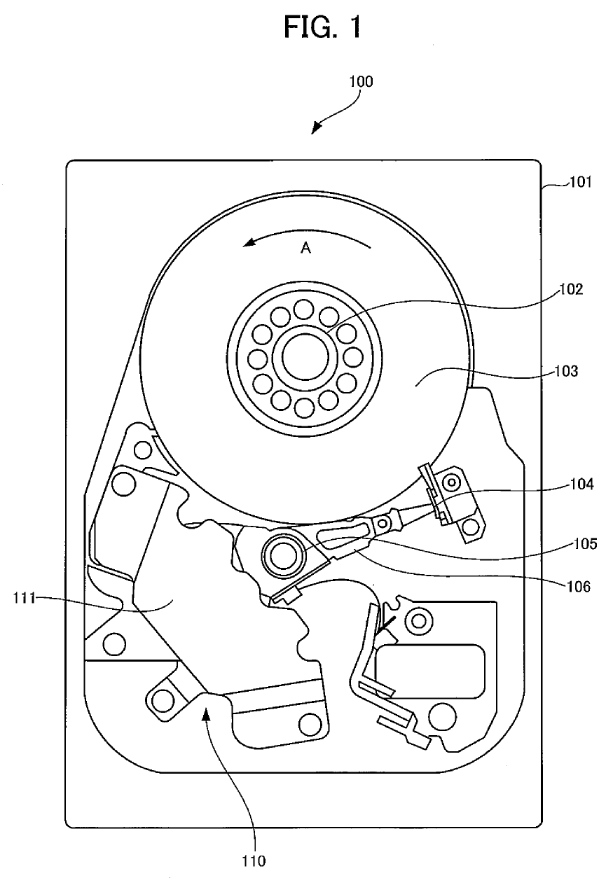

FIG. 1 is a view illustrating a hard disk drive (HDD) as a specific embodiment of the information storage device.

First, a HDD 100 illustrated in FIG. 1 includes a housing 101 and a magnetic disk 103 which is housed in the housing and is driven to be rotated about a rotary shaft 102 in a direction of an arrow A by a non-illustrated disk control motor. The HDD 100 also includes a carriage arm 106 and a voice coil motor 110. The carriage arm 106 has, on its tip end, a magnetic head 104 facing the magnetic disk 103, and rotates about a rotary shaft 105. The voice coil motor 110 moves the magnetic head 104 along a disc surface of the magnetic disk 103 by rotating the carriage arm 106. Here, the housing 101, the magnetic disk 103, the magnetic head 104 and the carriage arm 106 respectively correspond to examples of the housing, the recording medium, the head and the arm of the basic embodiment of the information storage device.

In the HDD 100, when information is recorded onto or reproduced from the magnetic disk 103, the carriage arm 106 is rotated by the voice coil motor 110, while the magnetic disk 103 is rotatably driven by a disk control motor. This rotation causes the magnetic head 104 on the tip end of the carriage arm 106 to move along the disc surface of the magnetic disk 103. By such movement of the magnetic head 104, the magnetic head 104 is positioned relative to the magnetic disk 103. Then, by the magnetic head 104 thus positioned, information is sequentially recorded or the recorded information is reproduced with the rotation of the magnetic disk 103.

The voice coil motor 110 has a coil to be described later and a magnet that generates a certain magnetic field to be applied to the coil. Specifically, the coil is fixed to a rear end of the carriage arm 106, which is opposed to the tip end at which the magnetic head 104 is held across the rotary shaft 105. The voice coil motor 110 rotates the carriage arm 106 by a force acting on the coil when a current is supplied to the coil.

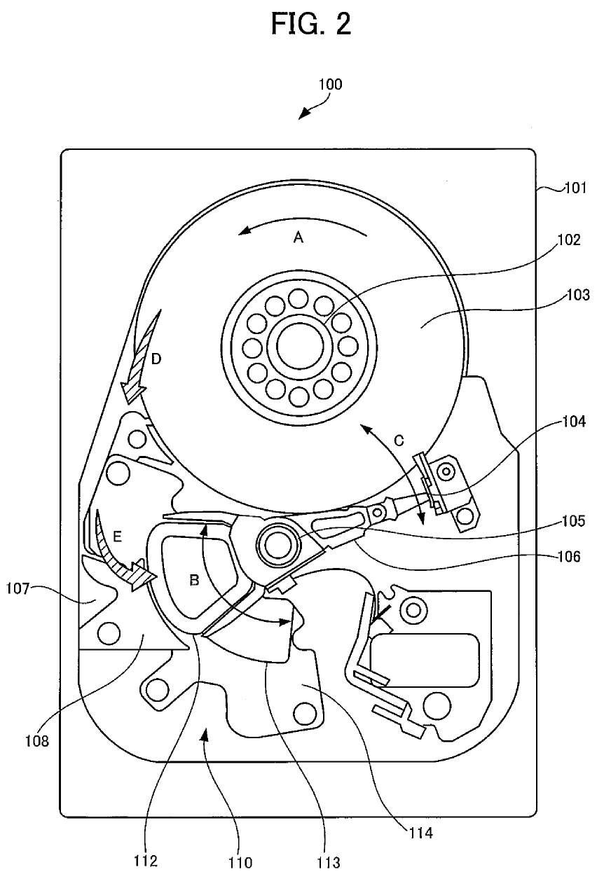

FIG. 2 is a view illustrating an internal structure of the voice coil motor in FIG. 1.

FIG. 2 illustrates the HDD 100 from which an upper cover 111 of the voice coil motor 110, which is illustrated in FIG. 1, is detached to view the internal structure of the voice coil motor in FIG. 1.

As illustrated in FIG. 2, the voice coil motor 110 has a coil 112 fixed to the rear end of the carriage arm 106. The coil 112 includes multiple turns in a plane where the carriage arm 106 rotates and is disposed between a permanent magnet 113 placed on a housing 101 bottom side of the coil 112 and a non-illustrated permanent magnet placed on an upper cover 111 side illustrated in FIG. 1. Then, the permanent magnet 113 on the housing 101 bottom side is fixed to a lower cover 114 attached to the bottom of the housing 101, while the permanent magnet on the upper cover 111 side is fixed to the upper cover 111. This structure enables the magnetic field to be always applied to the coil 112 by two permanent magnets that clamp the coil 112 therebetween. Moreover, each of the upper cover 111 and the lower cover 114 is formed of high magnetic permeability material and serves as a yoke through which a magnetic field line of the magnetic field passes.

When a current is supplied to the coil 112 of the voice coil motor 110 having such a structure, a force acts on the coil 112, and therefore the coil 112 moves in a direction illustrated by an arrow B in FIG. 2. Consequently, the carriage arm 106 rotates as illustrated by an arrow C in FIG. 2 to move the magnetic head 104 along the disc surface of the magnetic disk 103.

The coil 112 of the explained voice coil motor 110 and two permanent magnets which clamp the coil 112 to cause the magnetic field to act on the coil 112, respectively correspond to examples of the coil and the magnets in the explained basic embodiment.

At this time, heat is generated in the coil 112 of the voice coil motor 110 by the current supplied therein. The heat generated in the coil 112 increases an electric resistance of the coil itself to cause a problem such as reduction in current flowing through the coil, and therefore the coil 112 needs to be cooled appropriately.

Accordingly, in the HDD 100, wind generated in a direction of an arrow D by the rotation of the magnetic disk 103 circulates inside the housing 101, and thus is used to cool the coil 112 of the voice coil motor 110. For this reason, in the HDD 100, an opening is formed on the upper cover 111 of the voice coil motor 110 illustrated in FIG. 1 such that the wind flowing inside the housing 101 enters the interior of the voice coil motor 110. As a result, the wind generated by the rotation of the magnetic disk 103 flows as illustrated in an arrow E in FIG. 2 and blows against the coil 112 of the voice coil motor 110. Consequently, the coil 112 is appropriately cooled.

Moreover, in the HDD 100, a guide 107 for directing the wind to the coil 112 of the voice coil motor 110 is provided in the housing 101 so as to improve a cooling effect on the coil 112. This increases amount of wind flowing to the coil 112, among the wind generated by the rotation of the magnetic disk 103, thereby improving the cooling effect on the coil 112.

At this time, if turbulent flow or the like occurs in the wind blowing against the coil 112 of the voice coil motor 110, the wind vibrates the coil 112 and may eventually vibrate the carriage arm 106 having the coil 112 fixed thereto and holding the magnetic head 104 on its tip end. Occurrence of such vibration in the carriage arm 106 may cause trouble in recording or reproducing information on or from the magnetic disk 103 by the magnetic head 104.

Therefore, according to the present embodiment, an airflow adjusting plate 108 is placed at a position that is upstream to the coil 112 and downstream to the guide 107 along the wind flow toward the coil 112 of the voice coil motor 110. Specifically, the airflow adjusting plate 108 adjusts the wind flow toward the coil 112 to travel along the coil 112.

The airflow adjusting plate 108 is a plate that is positioned adjacent to the coil 112 of the voice coil motor 110 and extends on a plane where the coil 112 winds. In the present embodiment, the airflow adjusting plate 108 has the same thickness as that of the coil 112.

The airflow adjusting plate 108 corresponds to an example of the airflow adjusting plate of the basic embodiment.

Herein, an applied embodiment in which “the guide placed at a position further upstream to the airflow adjusting plate along the wind flow, and directing the wind to the airflow adjusting plate and the coil” is provided is preferable with respect to the basic embodiment.

According to the preferable applied embodiment, provision of the guide makes it possible to blow more wind to the coil and improve the cooling effect on the coil. Further, according to the preferable applied embodiment, the guide is placed at a position further upstream to the airflow adjusting plate along the wind flow, thereby making it possible to improve the cooling effect on the coil without interfering with the suppression of coil vibration.

In the present embodiment, the guide 107 in FIG. 2 is placed at a position further upstream to the airflow adjusting plate 108 along the wind flow and corresponds to an example of the guide in the applied embodiment.

The following will explain suppression of vibration of the coil 112 achieved by the rectifying effect of the airflow adjusting plate 108.

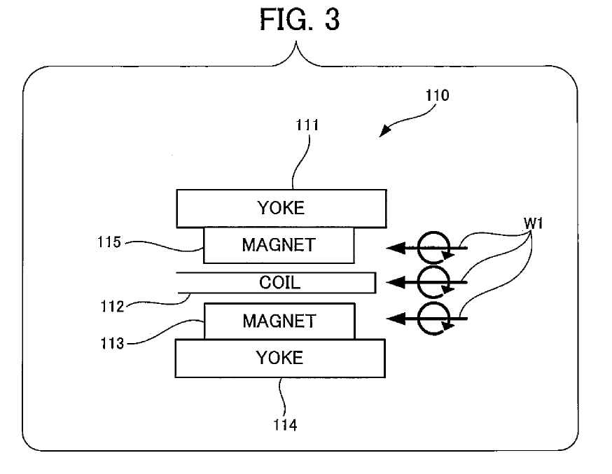

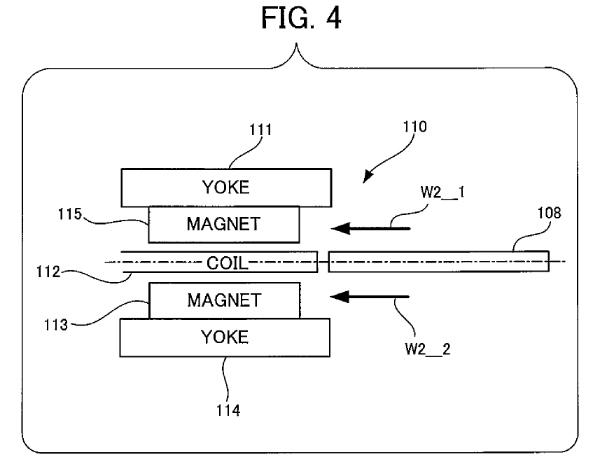

FIG. 3 is a schematic view illustrating a state in which vibration occurs in the coil of the voice coil motor on the assumption that no airflow adjusting plate is provided, and FIG. 4 is a schematic view illustrating a state in which wind blowing against the coil of the voice coil motor is rectified by the airflow adjusting plate of the present embodiment to thereby suppress vibration of the coil.

FIGS. 3 and 4 are schematic cross-sectional views taken along a longitudinal direction of the carriage arm 106 in the voice coil motor 110. Moreover, FIGS. 3 and 4 each illustrate the upper cover 111 of the voice coil motor 110 which is not illustrated in FIG. 2, and the permanent magnet 115 fixed to the upper cover 111.

Assuming that no airflow adjusting plate 108 of the present embodiment is provided, the wind guided to the coil 112 of the voice coil motor 110 by the guide 107 in FIG. 2 may hit against the coil 112 and two permanent magnets 113 and 115 which clamp the coil 112 therebetween as illustrated in FIG. 3, and then change into a turbulent flow. Then, wind W1 as the turbulent flow blows against the coil 112 to cause vibration of the coil.

By contrast, in the present embodiment, the flow of wind guided to the coil 112 is rectified to the flow along the coil 112 by the airflow adjusting plate 108 and is divided into wind W2_1 on the upper side of the coil 112 in FIG. 4 and wind W2_2 on the lower side thereof, so that the wind orderly blows against the upper and lower sides of the coil 112, respectively. As a result, generation of the turbulent flow is suppressed and the coil 112 is cooled in a state where vibration of not only the coil 112 but also of the carriage arm 106 is suppressed.

As described above, according to the HDD 100 of the present embodiment, it is possible to cool the coil 112 included in the voice coil motor 110, while suppressing vibration of the coil 112 by utilizing the wind generated by the rotation of the magnetic disk 103.

As an example of the airflow adjusting plate of the basic embodiment of the information storage device, the above exemplifies the airflow adjusting plate 108 having the same thickness as that of the coil included in the voice coil motor. However, the airflow adjusting plate of the basic embodiment is not limited to this. The airflow adjusting plate of the basic embodiment may be, for example, one having a thickness smaller than that of the coil included in the voice coil motor. Alternatively, on the contrary, the airflow adjusting plate may be one having a thickness larger than that of the coil.

As described above, according to the present embodiment, it is possible to obtain an information storage device capable of cooling a coil included in a voice coil motor, while suppressing vibration of the coil by utilizing wind generated by rotation of a magnetic disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information storage device comprising:
a housing;
a recording medium on which information is recorded, the recording medium having a disc shape, housed in the housing, and rotating along a disc surface to generate a wind inside the housing;
a head capable of recording and/or reproducing information on and/or from the recording medium;
an arm holding the head on a tip end thereof and held by a rotary shaft, the arm rotating about the rotary shaft to move the head along the disc surface of the recording medium;
a coil including multiple turns in a plane where the arm rotates, and receiving current supply, the coil being fixed to an end of the arm opposite to the tip end across the rotary shaft;
a magnet generating a magnetic field to act on the coil; and
an airflow adjusting plate placed at a position adjacent and upstream to the coil along the wind generated by rotation of the recording medium, the airflow adjusting plate extending in the plane where the coil includes turns and adjusting a flow of the wind to travel along the coil.

2. The information storage device according to claim 1, further comprising a guide placed at a position further upstream to the airflow adjusting plate along the wind, and directing the wind to the airflow adjusting plate and the coil.
